(19) United States
(12) Patent Application Publication
(10) Pub. No.: US 2024/0416248 A1
(43) Pub. Date: Dec. 19, 2024

(54) SYSTEM AND METHOD FOR PROVIDING REWARDS FOR IN-GAME ACHIEVEMENTS ACROSS MULTIPLE THIRD-PARTY GAME PLATFORMS

(71) Applicant: Cross-Metaverse Avatars LLC, Sheridan, WY (US)

(72) Inventors: Kelvin Troy, Dublin (IE); John Michael O'Connor, Down (IE)

(21) Appl. No.: 18/334,059

(22) Filed: Jun. 13, 2023

(51) Int. Cl. A63F 13/798; A63F 13/46

(52) U.S. Cl. CPC A63F 13/798; A63F 13/46

(57) ABSTRACT

A system and a method for providing rewards to a user for in-game achievements across multiple third-party game platforms are disclosed. The system includes a user account module for storing user profiles, an SDK module integrated with each game platform for defining in-game achievements and associated rewards, and an API module for receiving information about these achievements. The API module generates an achievement signal when a user completes an achievement. A processing module receives this signal, determines the corresponding rewards using the SDK module, and adds these rewards to the user's profile via the user account module, providing a personalized gaming experience across multiple platforms.

### FIELD OF THE PRESENT DISCLOSURE

The present disclosure relates to a system and method for providing rewards to a user for in-game achievements across multiple third-party game platforms, such as video games, metaverses, and other game platforms. More specifically, the present disclosure relates to a system that integrates with multiple third-party game platforms to track user achievements and rewards across multiple games therein.

### BACKGROUND

The advent of digital technology and high-speed internet connectivity has fundamentally changed the landscape of the gaming industry. Games are no longer standalone, isolated experiences but have evolved into complex, interconnected digital ecosystems, creating communities around themselves and providing gamers with an immersive environment to interact, compete, and collaborate. This shift has been further accelerated with the introduction of cloud gaming platforms, multiplayer online games, and mobile gaming applications. As a result, the gaming industry is becoming increasingly competitive, and game developers are continuously seeking new ways to retain existing players and attract new ones.

One such strategy that has been successful is the introduction of achievement systems and battle pass mechanisms. An achievement system is a metagaming concept where players are rewarded for reaching specific milestones within a game. These rewards can range from points, badges, or titles to digital items and unlockable content. A battle pass, on the other hand, is a type of monetization and reward system that provides players with additional content and rewards as they progress and complete specific challenges in the game. These strategies serve not only as an incentive mechanism that promotes continued engagement with the game, but also as a source of revenue generation for the game developers and publishers.

While these mechanisms have been successful in promoting user engagement and retention, they are typically designed to function within a single game or a specific gaming platform. In today's interconnected digital landscape where players often engage with multiple games across different platforms, this single-game focus has several inherent limitations. For instance, the progression and rewards that a player earns are isolated within a particular game or platform. This means that the time and effort a player invests in one game do not translate to any value or benefit in another game, even if both games are from the same developer or publisher. This can be frustrating for players, particularly those who play multiple games simultaneously or frequently switch between different games. Additionally, while these systems offer players the opportunity to earn rewards, the range of rewards is typically limited to in-game items and content. There is a lack of variety and innovation in the types of rewards offered, which can reduce the attractiveness and value of the reward system for players.

Therefore, there is a need for a more flexible, user-friendly, and cross-platform achievement and reward solution.

### SUMMARY

The present disclosure aims to address these problems by providing a platform that tracks user progress and achievements, integrates with partnered multiple third-party game platforms, and offers a variety of rewards to keep users engaged. The present disclosure rewards users with assets (digital items and customizable content) based on their achievements across multiple third-party game platforms. By collaborating with third-party game platforms that access user account data, the present disclosure offers a seamless and enjoyable experience without direct game integration.

In an aspect of the present disclosure, a system for providing rewards to a user for in-game achievements across multiple third-party game platforms is disclosed. The system comprises a user account module configured to store a user profile for the user. The system further comprises a Software Development Kit (SDK) module independently integrated with each one of the multiple third-party game platforms. The SDK module is configured to define one or more in-game achievements and one or more rewards associated with completing each of the one or more in-game achievements for the corresponding one of the multiple third-party game platforms. The system further comprises an Application Programming Interface (API) module independently integrated with each one of the multiple third-party game platforms and in communication with the SDK module to receive information about the defined in-game achievements. The API module is configured to generate an achievement signal in response to and including information related to the user completing at least one of the defined one or more in-game achievements for the corresponding one of the multiple third-party game platforms. The system further comprises a processing module in communication with the user account module, the SDK module and the API module of each one of the multiple third-party game platforms, and the user account module. The processing module is configured to receive, via the API module, the achievement signal from the API module of each one of the multiple third-party game platforms. The processing module is further configured to determine, via the SDK module, the one or more rewards correspondingly associated with the at least one of the defined one or more completed in-game achievement based on the information in the received achievement signal. The processing module is further configured to configure the user account module to add the determined one or more rewards to the user profile for the corresponding one of the multiple third-party game platforms.

In one or more embodiments, the SDK module is configured to define the one or more rewards in a form of one or more assets for utilization in the corresponding one of the multiple third-party game platforms.

In one or more embodiments, the user account module is configured to allow the user to convert the one or more rewards available in the user profile thereof into one or more assets, from a list of available assets provided to the user, for utilization in the corresponding one of the multiple third-party game platforms.

In one or more embodiments, the user account module comprises information about a subscription status of the user.

In one or more embodiments, the SDK module is configured to define the one or more in-game achievements and/or the one or more rewards associated with completing each of the one or more in-game achievements for the corresponding one of the multiple third-party game platforms based on the subscription status of the user.

In one or more embodiments, the user account module is configured to define the list of available assets provided to the user based on the subscription status of the user.

In one or more embodiments, the user account module is configured to define a conversion ratio for converting the one or more rewards into the one or more assets based on the subscription status of the user.

In one or more embodiments, the SDK module is configured to provide an interface to be implemented for selecting one or more milestones in a game play in one of games of the corresponding one of the multiple third-party game platforms to be defined as the one or more in-game achievements therefor.

In one or more embodiments, the user account module is configured to allow the user to link the multiple third-party game platforms to the user profile thereof.

In one or more embodiments, the user account module is configured to provide a user interface for allowing the user to check the one or more rewards and one or more assets available in the user profile thereof.

In another aspect of the present disclosure, a method for providing rewards to a user for in-game achievements across multiple third-party game platforms is disclosed. The method comprises storing a user profile for the user in a user account module. The method further comprises defining, via an SDK module integrated independently with each one of the multiple third-party game platforms, one or more in-game achievements and one or more rewards associated with completing each of the one or more in-game achievements for the corresponding one of the multiple third-party game platforms. The method further comprises generating, via an API module integrated independently with each one of the multiple third-party game platforms and in communication with the SDK module to receive information about the defined in-game achievements, an achievement signal in response to and including information related to the user completing at least one of the defined one or more in-game achievements for the corresponding one of the multiple third-party game platforms. The method further comprises determining the one or more rewards correspondingly associated with the at least one of the defined one or more completed in-game achievement based on the information in the received achievement signal. The method further comprises adding the determined one or more rewards to the user profile, stored in the user account module, for the corresponding one of the multiple third-party game platforms.

In one or more embodiments, the method further comprises configuring the SDK module to define a one or more rewards in the form of one or more assets for utilization in the corresponding one of the multiple third-party game platforms.

In one or more embodiments, the method further comprises configuring the user account module to allow the user to convert the one or more rewards available in the user profile thereof into one or more assets, from a list of available assets provided to the user, for utilization in the corresponding one of the multiple third-party game platforms.

In one or more embodiments, the method further comprises storing, in the user account module, information about a subscription status of the user.

In one or more embodiments, the method further comprises configuring the SDK module to define the one or more in-game achievements and/or the one or more rewards associated with completing each of the one or more in-game achievements for the corresponding one of the multiple third-party game platforms based on the subscription status of the user.

In one or more embodiments, the method further comprises configuring the user account module to define the list of available assets provided to the user based on the subscription status of the user.

In one or more embodiments, the method further comprises configuring the user account module to define a conversion ratio for converting the one or more rewards into the one or more assets based on the subscription status of the user.

In one or more embodiments, the method further comprises configuring the SDK module to provide an interface to be implemented for selecting one or more milestones in a game play in one of games of the corresponding one of the multiple third-party game platforms to be defined as the one or more in-game achievements therefor.

In one or more embodiments, the method further comprises configuring the user account module to allow the user to link the multiple third-party game platforms to the user profile thereof.

In one or more embodiments, the method further comprises configuring the user account module to provide a user interface for allowing the user to check the one or more rewards and one or more assets available in the user profile thereof.

In an aspect, a computer program is disclosed. The computer program comprises instructions which, when the computer program is executed by a processing unit, cause the processing unit to carry out steps of the aforementioned method.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a diagram of a computing arrangement for implementation of a system for providing rewards to a user for in-game achievements across multiple third-party game platforms, in accordance with one or more exemplary embodiments of the present disclosure;

FIG. 2 illustrates a diagram of a server, in accordance with one or more exemplary embodiments of the present disclosure;

FIG. 3 illustrates a diagram of a user device, in accordance with one or more exemplary embodiments of the present disclosure;

FIG. 4 illustrates a diagram of a system for providing rewards to a user for in-game achievements across multiple third-party game platforms, in accordance with one or more exemplary embodiments of the present disclosure;

FIG. 5 illustrates an exemplary user interface implemented for allowing user to check one or more rewards and one or more assets available in user profile thereof, in accordance with one or more exemplary embodiments of the present disclosure; and

FIG. 6 illustrates a flowchart listing steps involved in a method for providing rewards to a user for in-game achievements across multiple third-party game platforms, in accordance with one or more exemplary embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to the specific details described herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Unless specified otherwise in the following description, the terms “perform”, “calculate”, “computer-assisted”, “compute”, “establish”, “generate”, “configure”, “reconstruct”, and the like preferably relate to operations and/or processes and/or processing steps that change and/or generate data and/or convert the data into other data, wherein the data may be represented or be present in particular in the form of physical variables, for example in the form of electrical impulses. The expression “computer” should in particular be interpreted as broadly as possible in order in particular to cover all electronic devices having data processing properties. Computers may thus for example be personal computers, servers, programmable logic controllers (PLCs), hand-held computer systems, pocket PC devices, mobile radio devices and other communication devices able to process data in a computer-assisted manner, processors and other electronic data processing devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Moreover, in particular a person skilled in the art, with knowledge of the method claim/method claims, is of course aware of all routine possibilities for realizing products or possibilities for implementation in the prior art, and so there is no need in particular for independent disclosure in the description. In particular, these customary realization variants known to the person skilled in the art can be realized exclusively by hardware components or exclusively by software components. Alternatively and/or additionally, the person skilled in the art, within the scope of his/her expert ability, can choose to the greatest possible extent arbitrary combinations according to embodiments of the invention for hardware components and software components in order to implement realization variants according to embodiments of the invention.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux® (any distribution), Android®, iOS®, Windows®, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

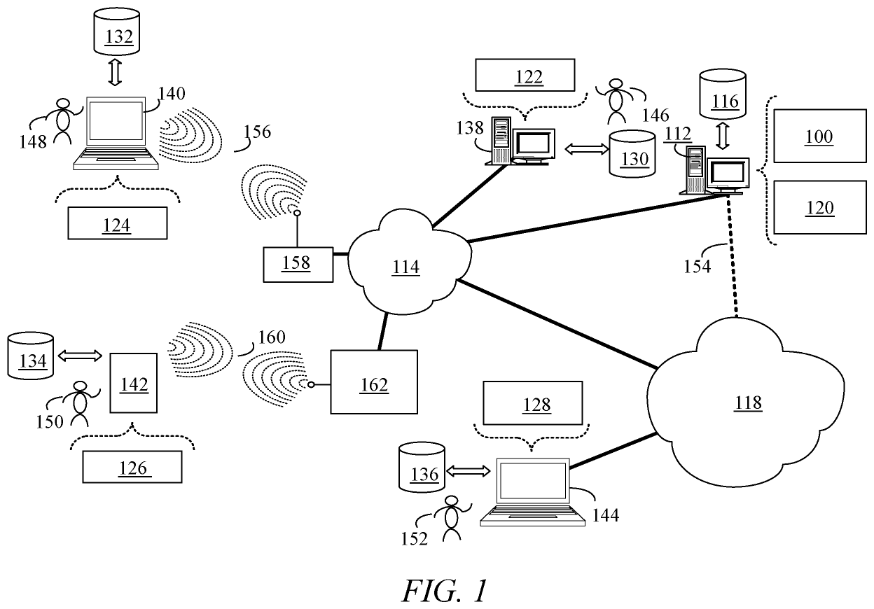

Referring to example implementation of FIG. 1, there is shown a computing arrangement 100 that may reside on and may be executed by a computer (e.g., computer 112), which may be connected to a network (e.g., network 114) (e.g., the internet or a local area network). Examples of computer 112 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft Windows®; Mac OS X®; Red Hat Linux®, or a custom operating system.

In some implementations, the instruction sets and subroutines of computing arrangement 100, which may be stored on storage device, such as storage device 116, coupled to computer 112, may be executed by one or more processors (not shown) and one or more memory architectures included within computer 112. In some implementations, storage device 116 may include but is not limited to: a hard disk drive; a flash drive, a tape drive; an optical drive; a RAID array (or other array); a RAM; and a ROM.

In some implementations, network 114 may be connected to one or more secondary networks (e.g., network 118), examples of which may include but are not limited to: a local area network; a wide area network; or an intranet, for example.

In some implementations, computer 112 may include a data store, such as a database (e.g., relational database, object-oriented database, triplestore database, etc.) and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing arrangement 100 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute application 120 for providing rewards to a user for in-game achievements across multiple third-party game platforms. In some implementations, computing arrangement 100 and/or application 120 may be accessed via one or more of client applications 122, 124, 126, 128. In some implementations, computing arrangement 100 may be a standalone application, or may be an applet/application/script/extension that may interact with and/or be executed within application 120, a component of application 120, and/or one or more of client applications 122, 124, 126, 128. In some implementations, application 120 may be a standalone application, or may be an applet/application/script/extension that may interact with and/or be executed within computing arrangement 100, a component of computing arrangement 100, and/or one or more of client applications 122, 124, 126, 128. In some implementations, one or more of client applications 122, 124, 126, 128 may be a standalone application, or may be an applet/application/script/extension that may interact with and/or be executed within and/or be a component of computing arrangement 100 and/or application 120. Examples of client applications 122, 124, 126, 128 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to user devices 138, 140, 142, 144, may be executed by one or more processors and one or more memory architectures incorporated into user devices 138, 140, 142, 144.

In some implementations, one or more of storage devices 130, 132, 134, 136, may include but are not limited to: hard disk drives; flash drives, tape drives; optical drives; RAID arrays; RAMs; and ROMs. Examples of user devices 138, 140, 142, 144 (and/or computer 112) may include, but are not limited to, a personal computer (e.g., user device 138), a laptop computer (e.g., user device 140), a smart/data-enabled, cellular phone (e.g., user device 142), a notebook computer (e.g., user device 144), a tablet (not shown), a server (not shown), a television (not shown), a smart television (not shown), a media (e.g., video, photo, etc.) capturing device (not shown), and a dedicated network device (not shown). User devices 138, 140, 142, 144 may each execute an operating system, examples of which may include but are not limited to, Android, Apple IOS, Mac OS X; Red Hat Linux, or a custom operating system.

In some implementations, one or more of client applications 122, 124, 126, 128 may be configured to effectuate some or all of the functionality of computing arrangement 100 (and vice versa). Accordingly, in some implementations, computing arrangement 100 may be a purely server-side application, a purely client-side application, or a hybrid server-side/client-side application that is cooperatively executed by one or more of client applications 122, 124, 126, 128 and/or computing arrangement 100.

In some implementations, one or more of client applications 122, 124, 126, 128 may be configured to effectuate some or all of the functionality of application 120 (and vice versa). Accordingly, in some implementations, application 120 may be a purely server-side application, a purely client-side application, or a hybrid server-side/client-side application that is cooperatively executed by one or more of client applications 122, 124, 126, 128 and/or application 120. As one or more of client applications 122, 124, 126, 128, computing arrangement 100, and application 120, taken singly or in any combination, may effectuate some or all of the same functionality, any description of effectuating such functionality via one or more of client applications 122, 124, 126, 128, computing arrangement 100, application 120, or combination thereof, and any described interaction(s) between one or more of client applications 122, 124, 126, 128, computing arrangement 100, application 120, or combination thereof to effectuate such functionality, should be taken as an example only and not to limit the scope of the disclosure.

In some implementations, one or more of users 146, 148, 150, 152 may access computer 112 and computing arrangement 100 (e.g., using one or more of user devices 138, 140, 142, 144) directly through network 114 or through secondary network 118. Further, computer 112 may be connected to network 114 through secondary network 118, as illustrated with phantom link line 154. Computing arrangement 100 may include one or more user interfaces, such as browsers and textual or graphical user interfaces, through which users 146, 148, 150, 152 may access computing arrangement 100.

In some implementations, the various user devices may be directly or indirectly coupled to communication network, such as communication network 114 and communication network 118, hereinafter simply referred to as network 114 and network 118, respectively. For example, user device 138 is shown directly coupled to network 114 via a hardwired network connection. Further, user device 144 is shown directly coupled to network 118 via a hardwired network connection. User device 140 is shown wirelessly coupled to network 114 via wireless communication channel 156 established between user device 140 and wireless access point (i.e., WAP) 158, which is shown directly coupled to network 114. WAP 158 may be, for example, an IEEE 802.11a, 802.11b, 802.11g. Wi-Fi, RFID, and/or Bluetooth (including Bluetooth Low Energy) device that is capable of establishing wireless communication channel 156 between user device 140 and WAP 158. User device 142 is shown wirelessly coupled to network 114 via wireless communication channel 160 established between user device 142 and cellular network/bridge 162, which is shown directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth (including Bluetooth Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

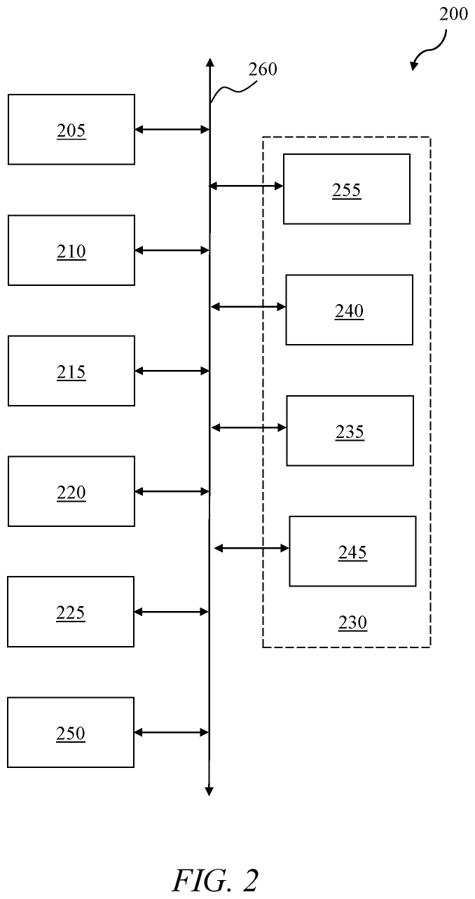

The computing arrangement 100 may include a server (such as server 200, as shown in FIG. 2) for providing rewards to a user for in-game achievements across multiple third-party game platforms. In the present implementations, the computing arrangement 100 itself may be embodied as the server 200. Herein, FIG. 2 is a block diagram of an example of the server 200 capable of implementing embodiments according to the present disclosure. In the example of FIG. 2, the server 200 may comprise hardware that includes processing circuitry (hereinafter referred to as a processing unit 205) for running software applications (such as, the application 120 of FIG. 1) and optionally an operating system. As illustrated, the server 200 may further include a database 210 which stores applications and data for use by the processing unit 205. Storage 215 provides non-volatile storage for applications and data and may include fixed disk drives, removable disk drives, flash memory devices, and CD-ROM, DVD-ROM or other optical storage devices. An optional user input device 220 may include devices that communicate user inputs from one or more users to the server 200 and may include keyboards, mice, joysticks, touch screens, etc. A communication or network interface 225 is provided which allows the server 200 to communicate with other computer systems via an electronic communications network, including wired and/or wireless communication and including an Intranet or the Internet. In one embodiment, the server 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the server 200. The components of the server 200, including the processing unit 205, the database 210, the data storage 215, the user input devices 220, the communication interface 225, and the display device 250, may be coupled via one or more data buses 260.

In the embodiment of FIG. 2, a graphics system 230 may be coupled with the data bus 260 and the components of the server 200. The graphics system 230 may include a physical graphics processing arrangement (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the database 210 and may be shared with the processing unit 205. Alternatively, the display memory 240 and/or additional memory 245 can be one or more separate memories provided for the exclusive use of the graphics system 230. In another embodiment, the graphics processing arrangement 230 may include one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. It is to be understood that the circuits and/or functionality of GPU as described herein could also be implemented in other types of processors, such as general-purpose or other special-purpose coprocessors, or within a CPU.

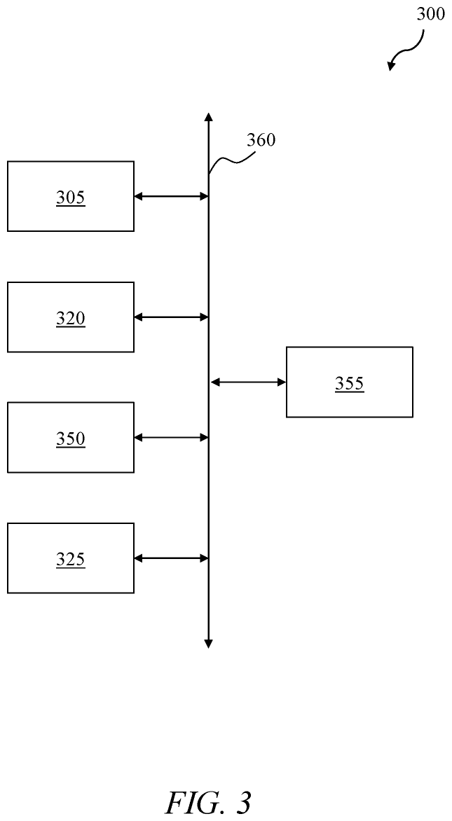

The computing arrangement 100 may also include a user device 300 (as shown in FIG. 3). In embodiments of the present disclosure, the user device 300 may embody a smartphone, a personal computer, a tablet, or the like. Herein, FIG. 3 is a block diagram of an example of the user device 300 capable of implementing embodiments according to the present disclosure. In the example of FIG. 3, the user device 300 may include a processor 305 (hereinafter, referred to as CPU 305) for running software applications (such as, the application 120 of FIG. 1) and optionally an operating system. A user input device 320 is provided which may include devices that communicates user inputs from one or more users and may include keyboards, mice, joysticks, touch screens, and/or microphones. Further, a network adapter 325 is provided which allows the user device 300 to communicate with other computer systems (e.g., the server 200 of FIG. 2) via an electronic communications network, including wired and/or wireless communication and including the Internet. The user device 300 may also include a decoder 355 may be any device capable of decoding (decompressing) data that may be encoded (compressed). A display device 350 may be provided which may be any device capable of displaying visual information, including information received from the decoder 355. In particular, as will be described below, the display device 350 may provide an interface, such that the display device 350 is configured to display information received from the server 200 of FIG. 2. The components of the user device 300 may be coupled via one or more data buses 360.

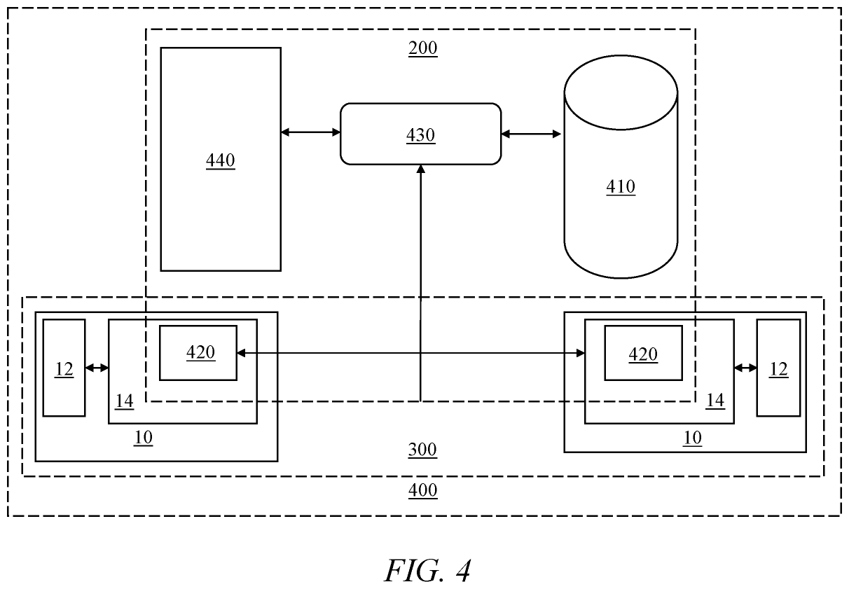

Referring to FIG. 4, illustrated is an exemplary block diagram of a system 400 for providing rewards to a user for in-game achievements across multiple third-party game platforms (two being shown and represented by reference numeral 10). The system 400, as described in the present disclosure, is integrated within the computing arrangement 100, and may be specifically implemented in the user device 300 in combination with (or without) the server 200 of the computing arrangement 100. Herein, the server 200 may manage and coordinate the necessary data, processing, and communication required for the proper functioning of the system 400. Simultaneously, the user device 300 may serve as an interactive interface for users to engage with the system 400, offering customization options, access to assets, and seamless interaction with the multiple real-time 3D rendering platforms. By implementing the system 400 within the server 200 and the user device 300, the present invention ensures a comprehensive and coherent framework for managing rewards for the user, as well as providing a consistent user experience across multiple third-party game platforms.

In context of the present disclosure, the third-party game platforms 10 refer to gaming platforms or systems that are owned, developed, and operated by entities, which may be separate from the present system 400. These platforms host their respective games and have their own user accounts and user data. These third-party platforms may be diverse and include console-based platforms such as Microsoft's Xbox®, Sony's PlayStation®, and Nintendo's® systems; computer-based platforms such as Steam®, Epic Games Store®, or GOG®; or even mobile-based platforms associated with app stores like Google's Play Store® and Apple's App Store®. The third-party game platforms 10 may support a variety of games across multiple genres, from action and adventure games to role-playing games (RPGs), strategy games, and more.

Specifically, in embodiments of the present disclosure, the third-party game platforms 10 include those platforms that provide rewards to the user for completing in-game achievements therein. Herein, the in-game achievements are typically predefined objectives or goals that a player (the user, with the two terms being interchangeably used hereinafter) may strive to complete within a game. These achievements may be designed to align with the game's progression, such as completing a specific level or defeating a certain enemy, or they may be optional challenges that require specific actions or skills from the player. The in-game achievements may involve completing a game task within a certain time, achieving a certain score, or discovering hidden or hard-to-reach areas. The in-game achievements may also be cumulative over time, such as collecting a certain number of items or defeating a certain number of enemies over the player's history in the game. Further, the rewards refer to the benefits or incentives that the player receives upon completing any of the in-game achievements. The rewards may come in many forms; for instance, the rewards may include digital items such as in-game currency, special equipment, or character skins. The rewards may also be in the form of points that contribute to a player's level or status within the game. The rewards and the in-game achievements contribute to a player's engagement with a game and the present system 400, as they provide a sense of accomplishment and progression.

It may be understood that each one of the multiple third-party game platforms 10 may include a game interface module (as represented by reference numeral 12) providing its own set of APIs, and may further provide SDKs, that allow external systems, like the present system 400 to interact with them and access relevant data. The game interface module 12 is a software framework designed for the development and execution of the game applications, such as video games, simulations, and virtual environments. Herein, the game interface module 12 may include at least one of the following popular and widely-used game engines, such as Unity Engine®, Unreal Engine®), Godot Engine®, CryEngine®). Each of these game engines offers unique capabilities and advantages, and the present disclosure may be implemented using any one or a combination of these engines to create a seamless and persistent game play and rewards experience across the multiple third-party game platforms 10.

Further, each one of the multiple third-party game platforms 10 may include an in-engine rewards module (as represented by reference numeral 14) to provide the user with rewards on completing at least one of the defined one or more in-game achievements for the corresponding one of the multiple third-party game platforms 10. The in-engine rewards module 14 is typically integrated directly into the corresponding third-party game platform 10. The in-engine rewards module 14 may operate within the third-party game platform 10 and interacts with various game mechanics and systems to track the user's progress and determine when they have achieved a specific goal or milestone. The in-engine rewards module 14 may utilize algorithms, data structures, and predefined rules to determine the eligibility and appropriate rewards for each completed achievement.

Further, as illustrated in FIG. 4, the system 400 includes a user account module 410, a SDK module 420, and an API module 430. The user account module 410 refers to a component within the system 400 that is responsible for managing and storing user profiles of the users. The user account module 410 is designed to handle user-related data and information, providing a centralized repository for storing and retrieving user profiles within the system 400. Herein, the user profile represents a collection of data and information associated with a specific user within the system 400, and may typically include personal details, preferences, settings, and other relevant information that characterizes the user within the context of the system 400. In some examples, the user account module 410 allows users to create, update, and manage their profiles, providing a personalized and consistent experience across multiple interactions and sessions within the system 400. The user account module 410 enables the system 400 to create and maintain user accounts by storing user profiles in a structured and secure manner. Further, the user account module 410 ensures the integrity and security of user profiles by implementing appropriate data management and access control mechanisms. In the present configuration, the user account module 410 may be implemented in the form of a database, such as a relational database, or storage system for this purpose, ensuring that the data remains accessible and consistent across different interactions and sessions.

The SDK module 420 is a software component that is independently integrated with each one of the multiple third-party game platforms 10 within the system 400, and may be implemented in the processing unit 205 of the server 200. The SDK module 420 is designed to provide a standardized set of tools, libraries, and resources that developers can use to define in-game achievements and associated rewards for each specific third-party game platform 10. The SDK module 420 acts as an interface between the system 400 and the third-party game platforms 10, enabling seamless integration and communication. As shown in FIG. 4, the SDK module 420 is integrated with the in-engine rewards module 14 of the corresponding one of the third-party game platforms 10. The SDK module 420 is configured to define one or more in-game achievements and one or more rewards associated with completing each of the one or more in-game achievements for the corresponding one of the multiple third-party game platforms 10. In particular, the SDK module 420 allows developers to leverage the functionality and capabilities of the in-engine rewards module 14 while implementing the present system 400 for defining in-game achievements and rewards. The SDK module 420 provides developers with a framework to define one or more in-game achievements for each individual third-party game platform 10. Additionally, the SDK module 420 allows developers to associate one or more rewards with each of the defined in-game achievements. By integrating the SDK module 420 with each third-party game platform 10, the system 400 ensures compatibility and consistency across multiple games. This allows the system 400 to define a unified approach to in-game achievements and rewards, regardless of the specific game engine or platform being used, which cannot be done using conventional systems.

Also, the API module 430 is a software component that enables the interoperability between the present system 400 and the multiple third-party game platforms 10, and may be implemented in the processing unit 205 of the server 200. The API module 430 is integrated independently with each third-party game platform 10, such that the API module 430 has the ability to communicate and interact with each of the third-party game platforms 10 individually, regardless of the specific game engine or platform being used. This independence ensures that the present system 400 remains flexible and adaptable to any third-party game platform 10 without requiring fundamental changes to its core infrastructure. The API module 430 is in communication with the SDK module 420, and is configured to receive information about the defined in-game achievements from the SDK module 420. This information exchange facilitates the tracking and validation of user's progress and achievements in the third-party game platforms 10. Herein, the API module 430 is configured to generate an achievement signal, which is generated in response to the user completing at least one of the defined in-game achievements on the corresponding third-party game platform 10. The achievement signal includes information related to the user's completed in-game achievement. This might encompass details such as the specific achievement completed, the time of completion, the game platform on which the achievement was completed, and potentially other relevant details.

The system 400 further includes a processing module 440, which in present embodiments may be executed in the processing unit 205 of the server 200. In other words, the processing module 440 may reside within the server 200, and specifically executed in the processing unit 205 therein, which ensures the processing module 440 has adequate computational resources to effectively coordinate operations of the present system 400. The server 200 also provides a robust and secure setting for the processing module 440, supporting high-availability and scalability as user base or game platform integrations expand. The processing module 205 is disposed in communication with the user account module 410, the SDK module 420 and the API module 430 of each one of the multiple third-party game platforms 10. Communication with the user account module 410 allows the processing module 440 to access and manage user-related data. The processing module 440 may retrieve user profiles, update them with new reward information, or utilize the stored data for personalized reward determinations based on a user's behavior or preferences. The interaction with the SDK module 420 allows the processing module 440 to understand the defined in-game achievements and associated rewards for each specific third-party game platform 10. By receiving this information from the SDK module 420, the processing module 440 may map incoming achievement signals (via the API module 430) to the appropriate rewards and user accounts. The interaction of the processing module 440 with the API module 430 from each of the third-party game platforms 10 ensures that it receives real-time updates about user's in-game achievements. These achievement signals are input for the processing module 440 to carry out its operations, including reward determination and allocation.

Specifically, the processing module 440 is configured to receive the achievement signal from the API module 430 of each one of the multiple third-party game platforms 10. This achievement signal is generated by the API module 430 upon the user accomplishing a predefined in-game achievement, serving as a digital announcement or alert of this event. The achievement signal carries pertinent details about the completed achievement, including information about the user who achieved it, the specific achievement completed, the game platform 10 on which the achievement was completed, and potentially other game-specific data. The achievement signal is transmitted from the API module 430 directly to the processing module 440 in near real-time, ensuring an instantaneous update about the user's accomplishment. By receiving this achievement signal, the processing module 440 if provided with information needed to fulfill operation of the present system, enabling it to determine the appropriate reward and assign it to the right user account, as discussed in detail in the proceeding paragraphs.

The processing module 440 is also configured to determine, via the SDK module 420, the one or more rewards correspondingly associated with the at least one of the defined one or more completed in-game achievement based on the information in the received achievement signal. That is, upon receipt of the achievement signal, the processing module 440 utilizes the SDK module 420 to determine the one or more rewards correspondingly associated with the completed in-game achievement. This determination process involves interpreting the information contained within the achievement signal, particularly identifying the specific in-game achievement that has been completed. The processing module 440 then communicates with the SDK module 420, which has been configured with the definitions of the in-game achievements and their associated rewards. The SDK module 420 provides the processing module 440 with information about the specific reward or rewards associated with the completed achievement, based on the definitions established during the integration process with each third-party game platform 10. This reward determination ensures the right rewards are allocated for each achievement, maintaining the integrity and attractiveness of the present system to the users.

The processing module 440 is further configured to configure the user account module 410 to add the determined one or more rewards to the user profile for the corresponding one of the multiple third-party game platforms 10. That is, once the processing module 440 has determined the appropriate rewards for the completed in-game achievement, the processing module 440 configures the user account module 410 to add these rewards to the user profile associated with the game platform 10 where the achievement took place. This involves communicating with the user account module 410, sending instructions to update the specific user profile with the new rewards. The user account module 410, responsible for managing and storing user profiles, receives these instructions and updates the user profile accordingly. Herein, the update may include the addition of the determined rewards to the user's account, effectively increasing the value or assets available to the user within the present system. Such update may also involve modifying other elements of the user profile, such as the user's achievement history, reward balance, or game statistics, depending on the specifics of the reward system and user profile structure.

In an embodiment, the SDK module 420 is configured to define the one or more rewards in a form of one or more assets for utilization in the corresponding one of the multiple third-party game platforms. That is, the SDK module 420 allows developers to define the rewards as assets that can be utilized within the specific third-party game platform 10. Assets refer to various digital elements that can be incorporated into the game, such as virtual items, character skins, weapons, power-ups, cosmetic enhancements, or any other form of content that enriches the gameplay or appearance of the player's in-game experience. By defining the rewards as assets, the SDK module 420 provides developers with the flexibility to create and offer a wide range of appealing and valuable in-game items. These assets may be designed to align with the theme, mechanics, and aesthetics of the corresponding third-party game platform, ensuring a seamless integration and cohesive player experience. The SDK module 420 facilitates the process of defining the assets as rewards by providing developers with a set of tools and functionalities. These tools may include an asset creation framework, which allows developers to design and generate the assets within the parameters and specifications of the specific game platform, and may also include asset management features, enabling developers to organize, categorize, and store the assets in a structured manner for easy access and integration.

Furthermore, the SDK module 420 may offer functionalities to assign specific attributes, properties, or functionalities to the defined assets. This allows developers to enhance the rewards with unique characteristics, such as special abilities, rarity levels, unlockable features, or any other attributes that add value and desirability to the assets within the game platform 10. Once the assets are defined using the SDK module 420, they may be seamlessly integrated into the corresponding third-party game platform 10. This integration ensures that the assets are accessible and usable by the players upon completing the associated in-game achievements. The rewards in the form of assets may be added to the player's inventory (via the user account module 410), or unlocked for immediate use depending on the design and mechanics of the specific game platform 10. Moreover, because the present system 400 allows for these rewards to be defined and implemented across multiple third-party game platforms 10, the users have the opportunity to earn and utilize their rewards in a variety of gaming environments. This level of flexibility and broad application potential makes this approach to reward definition highly appealing to both game developers as well as the users.

In an embodiment, the user account module 410 is configured to allow the user to convert the one or more rewards available in the user profile thereof into one or more assets, from a list of available assets provided to the user, for utilization in the corresponding one of the multiple third-party game platforms. Once a user earns or accumulates rewards through completing in-game achievements, these rewards are stored in their user profile within the system 400. The user account module 410 is responsible for managing and facilitating the conversion of these rewards into assets that can be utilized in the specific third-party game platform. Herein, the user account module 410 is configured to enable users to convert the rewards available in their user profile into assets that may be utilized within the corresponding third-party game platform 10. This conversion process involves allowing users to select and acquire assets from a list of available options provided to them. To initiate the conversion process, the user is given access to a list of available assets. This list includes a variety of assets that have been made accessible to the user as potential options for conversion. These assets may include virtual items, character customization options, in-game currency, power-ups, or any other form of content that can be utilized within the game platform. The user account module 410 provides an interface or functionality that allows the user to browse through the available assets and make selections based on their preferences or desired in-game enhancements. The user may choose one or more assets from the provided list to convert their accumulated rewards into. Once the user has made their selection, the user account module 410 facilitates the conversion process. This involves deducting the corresponding number of rewards from the user's profile and granting them ownership or access to the selected assets. The converted assets are then added to the user's inventory within the corresponding third-party game platform 10. By allowing users to convert their rewards into assets, the system 400 enhances the flexibility and customization options available to the users.

In an embodiment, the user account module 410 comprises information about a subscription status of the user. Herein, the subscription status provides important context and influences the functionalities and features available to the user within the system 400. The subscription status helps determine the level of access and privileges the user has, as well as any additional benefits or restrictions associated with their subscription. This information about the subscription status is stored within the user's profile and indicates whether the user has an active subscription to the platform provided by the system 400 or any relevant services associated with it. Thereby, in the present configuration, the user account module 410 uses the subscription status as a basis for defining and customizing the in-game achievements and rewards within the corresponding third-party game platforms 10.

In an embodiment, the SDK module 420 is configured to define the one or more in-game achievements and/or the one or more rewards associated with completing each of the one or more in-game achievements for the corresponding one of the multiple third-party game platforms 10 based on the subscription status of the user. That is, the SDK module 420, which is responsible for defining the in-game achievements and associated rewards, takes into account the subscription status of the user to tailor the experiences and incentives provided to them. Based on the subscription status, the SDK module 420 may determine the specific set of in-game achievements and rewards that are available to the user. For example, if a user has a premium subscription, the SDK module 420 may define high-value achievements or exclusive rewards that are specifically designed for premium subscribers. These achievements and rewards may include rare items, unique in-game abilities, or access to premium features not accessible to non-subscribed users. By considering the subscription status, the system 400 may provide differentiated experiences and incentives to users based on their level of engagement and investment in the game platform 10.

In an embodiment, the user account module 410 is configured to define the list of available assets provided to the user based on the subscription status of the user. As discussed, the user account module 410 is responsible for defining the list of available assets that are provided to the user within the system 400, and the availability of these assets is determined based on the subscription status of the user. Herein, the user account module 410 takes into account the subscription status of the user to curate a personalized and relevant list of assets that may be accessed by the user. Users with different subscription statuses may have access to different sets of assets. Users with an active subscription may have access to a broader range of achievements and rewards compared to non-subscribed users. The subscription status may unlock exclusive or premium achievements and rewards that are not available to users without a subscription. For instance, users with a premium subscription may be granted access to a wider range of high-value or exclusive assets that are not available to users without a subscription or with a basic/free subscription. The user account module 410 considers the subscription status and determines the specific assets that are appropriate for each user category. This ensures that users are presented with assets that align with their subscription level and provide a meaningful and valuable experience within the system 400.

In an embodiment, the user account module is configured to define a conversion ratio for converting the one or more rewards into the one or more assets based on the subscription status of the user. That is, the user account module 410 also defines a conversion ratio for converting the rewards earned by the user into assets, which is determined based on the user's subscription status. The conversion ratio represents the exchange rate or ratio at which the earned rewards may be converted into assets from the list of available assets. In other words, the conversion ratio determines how many rewards are required to obtain a particular asset. The conversion ratio may vary depending on the subscription status of the user, with different ratios set for different subscription tiers. For example, users with a higher subscription tier or a premium subscription may have a more favorable conversion ratio, allowing them to convert a smaller number of rewards into assets compared to users with a lower subscription tier or a free/basic subscription. By customizing the list of available assets and defining the conversion ratio based on the subscription status, the system 400 ensures that the rewards earned by users are converted into assets in a manner that reflects their subscription level and provides a fair and balanced value exchange.

In an embodiment, the SDK module 420 is configured to provide an interface to be implemented for selecting one or more milestones in a game play in one of games of the corresponding one of the multiple third-party game platforms 10 to be defined as the one or more in-game achievements therefor. Herein, the SDK module 420 provides the interface that allows game developers or administrators to identify specific milestones or accomplishments within a game that may be recognized as in-game achievements. These milestones represent significant accomplishments or objectives that players may strive to achieve during their gameplay experience. Through the provided interface, developers or administrators may browse through the game's mechanics, gameplay elements, and story progression to identify suitable milestones. These milestones may be associated with various actions, events, challenges, or progressions within the game. Examples of milestones may include completing a level, defeating a character, reaching a certain score, unlocking a new area, or acquiring a specific item. These milestones are then defined as in-game achievements. Once the milestones have been selected and defined as in-game achievements, they become recognizable and trackable within the system 400. The users may then engage in the game and strive to accomplish these milestones to earn rewards and recognition for their progress and accomplishments.

In an embodiment, the user account module 410 is configured to allow the user to link the multiple third-party game platforms 10 to the user profile thereof. This functionality allows users to connect their accounts from the multiple third-party game platforms 10 to their centralized user profile. For this purpose, the users are typically required to provide their login credentials or authorize access to their accounts on the respective third-party game platforms 10. This authentication process ensures that the user's identity and ownership of the accounts are verified. Once the user has successfully linked their accounts, the user account module 410 establishes a connection between the user profile and the associated third-party game platforms 10. This connection enables the system 400 to retrieve relevant data and information from the linked platforms, such as game progress, achievements, and rewards. Thereby, the system 400 enables the users to seamlessly connect with the multiple third-party game platforms 10 from a single location, without discrete integration or modification to each of the multiple third-party game platforms 10.

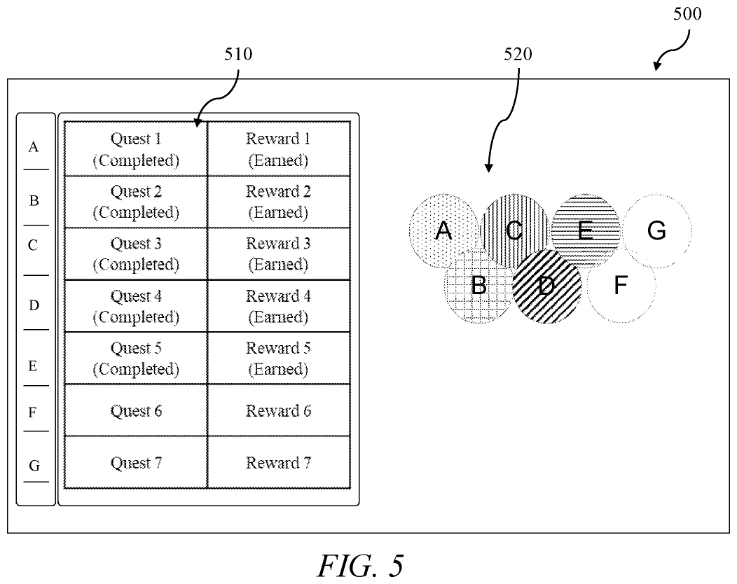

In an embodiment, the user account module 410 is configured to provide a user interface (as illustrated in FIG. 5, referred by reference numeral 500) for allowing the user to check the one or more rewards and one or more assets available in the user profile thereof. The user interface 500 provides a visual representation of the user's profile and presents the rewards and assets in a clear and organized manner. When the user access the user interface 500, the user is presented with a dashboard or a dedicated section that displays their user profile information. The user interface 500 may provide a first section 510 that allow the users to view their rewards and assets separately. The first section 510 provides a comprehensive list of the rewards that the user has earned or received through various in-game achievements or activities. Each reward is typically accompanied by relevant details, such as the corresponding achievement, the game it was obtained from, and any additional information or requirements associated with the reward. Further, the user interface 500 may provide a second section 520 that allow the users to view available in-game achievements that may be completed to earn more rewards. In an example, as illustrated, the second section 520 may present the in-game achievements as overlapping bubbles A-F, which may make the user interface 500 more interactive, visually appealing, and intuitive for users. These bubbles A-F may represent the in-game achievements available in different third-party game platforms 10, and may be unique in size, color, or design, depending on factors such as the difficulty level of the corresponding in-game achievement, the reward associated therewith, or the game it belongs to. Further, the overlapping bubbles A-F may symbolize the interconnectivity between different in-game achievements and their corresponding games. In general, the user interface 500 may allow the users to explore and manage their rewards and assets, such as by selecting individual items to view detailed information or perform actions such as redeeming rewards or utilizing assets within specific third-party game platform 10.

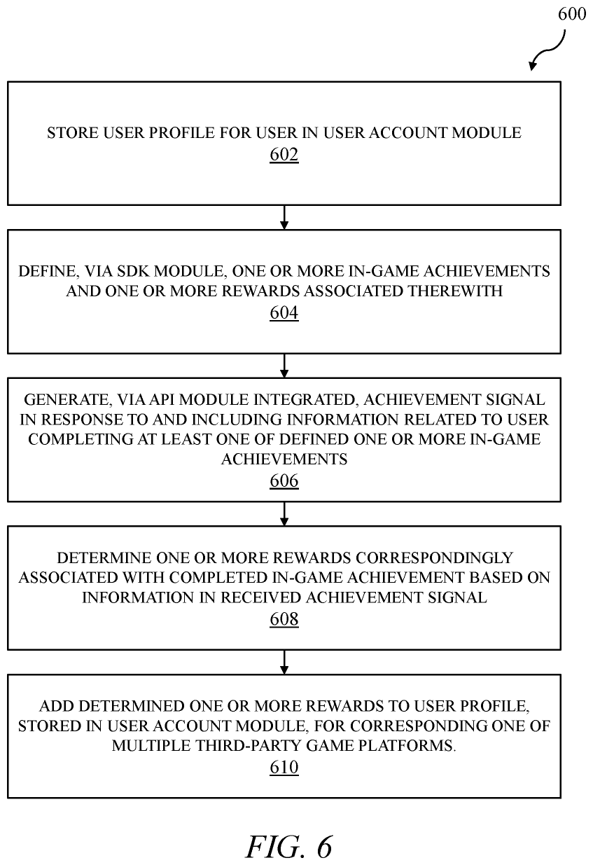

The present disclosure further provides a method for providing rewards to a user for in-game achievements across multiple third-party game platforms 10. Referring now to FIG. 6, illustrated is a flowchart for the said method (as represented by reference numeral 600) listing steps involved therein. Various embodiments and variants disclosed above with respect to the system 400 shown in FIG. 4 for providing rewards to a user for in-game achievements across multiple third-party game platforms 10 apply mutatis mutandis to the present method 600. Thus, the details as described above with respect to specific elements have not been repeated herein for brevity of the present disclosure. Also, it may be contemplated that steps (as described hereinafter) for the method 600 are only illustrative and other alternatives can also be provided where one or more steps are added, one or more steps are removed, or one or more steps are provided in a different sequence without departing from the spirit and the scope of the present disclosure.

At step 602, the method 600 includes storing a user profile for the user in the user account module 410. This step 602 involves creating a dedicated storage space where the user's information, preferences, and progress can be securely stored and accessed. At step 604, the method 600 includes defining, via the SDK module 420 integrated independently with each one of the multiple third-party game platforms 10, one or more in-game achievements and one or more rewards associated with completing each of the one or more in-game achievements for the corresponding one of the multiple third-party game platforms 10. This step 604 allows for the independent integration with each third-party game platform 10. The SDK module 420 enables the game developers to establish specific objectives and corresponding rewards that users may carn upon completing those objectives within their respective games. At step 606, the method 600 includes generating, via the API module 430 integrated independently with each one of the multiple third-party game platforms 10 and in communication with the SDK module 420 to receive information about the defined in-game achievements, the achievement signal in response to and including information related to the user completing at least one of the defined one or more in-game achievements for the corresponding one of the multiple third-party game platforms 10. This step 606 involves establishing a communication channel between the third-party game platforms 10 and the SDK module 420. This allows the API module 430 to receive information about the defined in-game achievements when the user completes them, triggering the generation of the achievement signal. At step 608, the method 600 includes determining the one or more rewards correspondingly associated with the at least one of the defined one or more completed in-game achievement based on the information in the received achievement signal. This step 608 provides that the information in the achievement signal is analyzed, such as the specific achievement accomplished and any additional parameters, to identify and determine the appropriate rewards to be granted to the user. At step 610, the method 600 includes adding the determined one or more rewards to the user profile, stored in the user account module 410, for the corresponding one of the multiple third-party game platforms 10. This step 610 ensures that the user's profile accurately reflects their accomplishments and available rewards for the corresponding third-party game platform 10. The user may later access and utilize these rewards as desired, enhancing their gaming experience.

In one or more embodiments, the method 600 also includes configuring the SDK module 420 to define the one or more rewards in a form of one or more assets for utilization in the corresponding one of the multiple third-party game platforms 10. This step involves specifying digital items, such as skins, weapons, or virtual currency, that users may carn and utilize within their respective game platforms 10. The method 600 further includes configuring the user account module 410 to allow the user to convert the one or more rewards available in the user profile thereof into one or more assets, from a list of available assets provided to the user, for utilization in the corresponding one of the multiple third-party game platforms 10. This enables the users to select and transform their earned rewards into specific in-game items or resources, enhancing their gameplay experience.

In one or more embodiments, the method 600 also includes storing, in the user account module 410, information about the subscription status of the user. This involves keeping track of whether the user has subscribed to any premium services or features offered by the present system 400 and/or the gaming platform 10. In an embodiment, the method 600 includes configuring the SDK module 420 to define the one or more in-game achievements and/or the one or more rewards associated with completing each of the one or more in-game achievements for the corresponding one of the multiple third-party game platforms 10 based on the subscription status of the user. This allows for tailored objectives and corresponding rewards to be established, taking into account the user's subscription level or benefits. In another embodiment, the method 600 includes configuring the user account module 410 to define the list of available assets provided to the user based on the subscription status of the user. This ensures that the selection of assets for conversion is appropriately aligned with the user's subscription benefits or limitations. In still another embodiment, the method 600 includes configuring the user account module 410 to define the conversion ratio for converting the one or more rewards into the one or more assets based on the subscription status of the user. This involves establishing a predetermined conversion ratio taking into consideration the user's subscription level that determines how many rewards can be exchanged for a specific asset.

In one or more embodiments, the method 600 also includes configuring the SDK module 420 to provide the interface to be implemented for selecting one or more milestones in a game play in one of games of the corresponding one of the multiple third-party game platforms 10 to be defined as the one or more in-game achievements therefor. That is, the SDK module 420 provides the interface for selecting milestones for game(s) in the corresponding game platform 10, which in turn allows the players to choose specific accomplishments or objectives within their gameplay that will be designated as in-game achievements, contributing to their progress and potential rewards. In an embodiment, the method 600 further includes configuring the user account module 410 to allow the user to link the multiple third-party game platforms 10 to the user profile thereof. This enables users to connect and integrate their various game accounts into a centralized profile, facilitating seamless tracking and management of their achievements and rewards. In an embodiment, the method 600 includes configuring the user account module 410 to provide the user interface 500 for allowing the user to check the one or more rewards and one or more assets available in the user profile thereof. The user interface 500 allows the users to conveniently view and monitor the earned rewards and assets they have accumulated across multiple third-party game platforms 10, ensuring transparency and easy access to their inventory.

The system 400 and the method 600 of the present disclosure helps in managing and rewarding in-game achievements across the multiple third-party game platforms 10. The present disclosure provides a seamless, consistent, and unified approach to rewards and achievements, thus enhancing user experience and engagement. The present system 400 is built on top of the third-party game platforms 10 for creating immersive and rewarding game experiences. The present system 400, communicating with the game platform 10, tracks the user's progress and decides when they have achieved a goal, enhancing the transparency and objectivity of the rewards process. Thus, the system 400 allows for cross-platform interoperability, seamless user experience, and efficient tracking and rewarding of in-game achievements, proving advantageous to both game developers and users.

The foregoing descriptions of specific embodiments of the present disclosure have been presented for purposes of illustration and description. Those are not intended to be exhaustive or to limit the present disclosure to the precise forms disclosed, and obviously many modifications and variations are possible in light of the above teaching. The exemplary embodiments have been chosen and described in order to best explain the principles of the present disclosure and its practical applications, to thereby enable others skilled in the art to best utilize the present disclosure and various embodiments with various modifications as are suited to the particular use contemplated. Modifications to embodiments of the present disclosure described in the foregoing are possible without departing from the scope of the present disclosure as defined by the accompanying claims.

What is claimed is:

1. A system for providing rewards to a user for in-game achievements across multiple third-party game platforms, the system comprising:
a user account module configured to store a user profile for the user;
a Software Development Kit (SDK) module independently integrated with each one of the multiple third-party game platforms, the SDK module configured to define one or more in-game achievements and one or more rewards associated with completing each of the one or more in-game achievements for the corresponding one of the multiple third-party game platforms;
an Application Programming Interface (API) module independently integrated with each one of the multiple third-party game platforms and in communication with the SDK module to receive information about the defined in-game achievements, the API module configured to generate an achievement signal in response to and including information related to the user completing at least one of the defined one or more in-game achievements for the corresponding one of the multiple third-party game platforms; and
a processing module in communication with the user account module, the SDK module and the API module of each one of the multiple third-party game platforms, the processing module configured to:
receive, via the API module, the achievement signal from the API module of each one of the multiple third-party game platforms;
determine, via the SDK module, the one or more rewards correspondingly associated with the at least one of the defined one or more completed in-game achievements based on the information in the received achievement signal; and
configure the user account module to add the determined one or more rewards to the user profile for the corresponding one of the multiple third-party game platforms.

2. The system of claim 1, wherein the SDK module is configured to define the one or more rewards in a form of one or more assets for utilization in the corresponding one of the multiple third-party game platforms.

3. The system of claim 1, wherein the user account module is configured to allow the user to convert the one or more rewards available in the user profile thereof into one or more assets, from a list of available assets provided to the user, for utilization in the corresponding one of the multiple third-party game platforms.

4. The system of claim 3, wherein the user account module comprises information about a subscription status of the user.

5. The system of claim 4, wherein the SDK module is configured to define the one or more in-game achievements and/or the one or more rewards associated with completing each of the one or more in-game achievements for the corresponding one of the multiple third-party game platforms based on the subscription status of the user.

6. The system of claim 4, wherein the user account module is configured to define the list of available assets provided to the user based on the subscription status of the user.

7. The system of claim 4, wherein the user account module is configured to define a conversion ratio for converting the one or more rewards into the one or more assets based on the subscription status of the user.

8. The system of claim 1, wherein the SDK module is configured to provide an interface to be implemented for selecting one or more milestones in a game play in one of games of the corresponding one of the multiple third-party game platforms to be defined as the one or more in-game achievements therefor.

9. The system of claim 1, wherein the user account module is configured to allow the user to link the multiple third-party game platforms to the user profile thereof.

10. The system of claim 1, wherein the user account module is configured to provide a user interface for allowing the user to check the one or more rewards and one or more assets available in the user profile thereof.

11. A method for providing rewards to a user for in-game achievements across multiple third-party game platforms, the method comprising:
storing a user profile for the user in a user account module;
defining, via a Software Development Kit (SDK) module integrated independently with each one of the multiple third-party game platforms, one or more in-game achievements and one or more rewards associated with completing each of the one or more in-game achievements for the corresponding one of the multiple third-party game platforms;
generating, via an Application Programming Interface (API) module integrated independently with each one of the multiple third-party game platforms and in communication with the SDK module to receive information about the defined in-game achievements, an achievement signal in response to and including information related to the user completing at least one of the defined one or more in-game achievements for the corresponding one of the multiple third-party game platforms;
determining the one or more rewards correspondingly associated with the at least one of the defined one or more completed in-game achievement based on the information in the achievement signal; and
adding the determined one or more rewards to the user profile, stored in the user account module, for the corresponding one of the multiple third-party game platforms.

12. The method of claim 11 further comprising configuring the SDK module to define the one or more rewards in a form of one or more assets for utilization in the corresponding one of the multiple third-party game platforms.

13. The method of claim 11 further comprising configuring the user account module to allow the user to convert the one or more rewards available in the user profile thereof into one or more assets, from a list of available assets provided to the user, for utilization in the corresponding one of the multiple third-party game platforms.

14. The method of claim 13 further comprising storing, in the user account module, information about a subscription status of the user.

15. The method of claim 14 further comprising configuring the SDK module to define the one or more in-game achievements and/or the one or more rewards associated with completing each of the one or more in-game achievements for the corresponding one of the multiple third-party game platforms based on the subscription status of the user.

16. The method of claim 14 further comprising configuring the user account module to define the list of available assets provided to the user based on the subscription status of the user.

17. The method of claim 14 further comprising configuring the user account module to define a conversion ratio for converting the one or more rewards into the one or more assets based on the subscription status of the user.

18. The method of claim 11 further comprising configuring the SDK module to provide an interface to be implemented for selecting one or more milestones in a game play in one of games of the corresponding one of the multiple third-party game platforms to be defined as the one or more in-game achievements therefor.

19. The method of claim 11 further comprising configuring the user account module to allow the user to link the multiple third-party game platforms to the user profile thereof.

20. The method of claim 11 further comprising configuring the user account module to provide a user interface for allowing the user to check the one or more rewards and one or more assets available in the user profile thereof.
